(19) United States
(12) Patent Application Publication
(10) Pub. No.: US 2010/0215925 A1
(43) Pub. Date: Aug. 26, 2010

(54) PRINTED THERMOPLASTIC FILM HAVING A PVB INK LAYER AND A RADIATION-CURED OVERPRINT COATING

(75) Inventors: Yuhming Chen, Yorktown, VA (US); Paul Georgelos, Naperville, IL (US)

Correspondence Address: MCANDREWS HELD & MALLOY, LTD, 500 WEST MADISON STREET, SUITE 3400, CHICAGO, IL, 60661, US

(73) Assignee: PLIANT CORPORATION, Schaumburg, IL (US)

(21) Appl. No.: 12/517,029

(22) PCT Filed: Nov. 29, 2007
(86) PCT No.: PCT/US07/85940

§ 371 Date: Apr. 28, 2010

Related U.S. Application Data
(63) Continuation of application No. 11/565,103, filed on Nov. 30, 2006.

(51) Int. Cl. B41F 31/00; B32B 3/10; B05D 3/06

(52) U.S. Cl. 428/203; 101/491; 427/503

(57) ABSTRACT

A printed thermoplastic film having a radiation-curable overprint coating is disclosed. The thermoplastic film is printed with an ink system that comprises a polyvinyl butyral carrier resin, a pigment dispersed in the carrier resin, a solvent, a plasticizer, and a coupling agent. The polyvinyl butyral based ink system provides better adhesion to the thermoplastic film than conventional nitrocellulose-based inks when used in conjunction with the radiation-curable overprint coating.

### FIELD OF THE INVENTION

The present technology relates to improved printed thermoplastic films used in packaging applications, particularly printed thermoplastic films having a radiation-cured overprint coating. More specifically, the present technology relates to thermoplastic films printed or provided with an ink layer comprising a modified polyvinyl butyral ink having improved adhesion compared to conventional inks, such as nitrocellulose and polyamide-based inks, when used in conjunction with coated, thermoplastic films.

### BACKGROUND OF THE INVENTION

Printed thermoplastic films for use in food packaging applications are well known. Generally, printed images are applied to the non-food outside layer of the packaging film (i.e., the side of the film opposite the food contact side) utilizing printing techniques that are known in the art. Such printing techniques include gravure, rotary screen, or flexographic techniques.

Ink systems for forming the printed image or wording on the thermoplastic films are also known in the art. Standard or conventional ink systems typically include pigments carried in a resin which may be solubilized in a carrier solvent. Such conventional ink resins include one or more of nitrocellulose, polyamide, polyurethane, ethyl cellulose, and polyvinyl butyral. Nitrocellulose and polyamides are the two most common resins with the overwhelming majority of usage for imparting flexo ink printing in the thermoplastic film industry. Typical carrier solvents for the resins include water, or hydrocarbon solvents, such as alcohols, acetates, aliphatic hydrocarbons, aromatic hydrocarbons, and ketones.

The demands placed upon the performance characteristics of printed thermoplastic films used in food applications have made it difficult for film manufacturers to deliver thermoplastic films and packaging materials having high quality, durable printed images that have good adhesion to the thermoplastic film. For example, printed thermoplastic films must be able to withstand the heat applied during sealing operations to form the package without degrading or distorting the printed image. Further, the printed package must also withstand the flexing, abrasion and rubbing that can occur during shipping and handling of the packaged product. Such handling of the packaged product can cause the printed image to flake, crack or “pick-off” from the film substrate, resulting in an undesirable loss of aesthetics in the appearance of the end user printed film.

A number of strategies have been employed to reduce flaking and cracking of printed inks on the thermoplastic films to improve the appearance thereof. One such strategy is to employ a “trap-print” film, which is a top film layer laminated to the substrate film with the printed layer sandwiched in between. The trap-print layer helps to protect the printed layer from abrasion and degradation. However, employing a trap-print layer requires an additional laminating step during manufacture which increases the cost and complexity of the film manufacturing process.

Another method for protecting the printed layer of a thermoplastic film is disclosed in U.S. Pat. No. 6,528,127 to Edlein et al. This patent discloses the use of a pigment-free radiation-curable coating which is applied over the printed layer and subsequently cured to form a protective layer over the printed image. According to the patent, carrier resins, such as nitrocellulose, polyamide, polyurethane, ethyl cellulose, cellulose acetate propionate, (meth)acrylates, poly(vinyl butyral), poly(vinyl acetate) and poly (vinyl chloride), can be used for the ink systems, with a blend of nitrocellulose/polyurethane being preferred. Such conventional ink systems, however, do not have sufficient adhesion to the film substrate, particularly polyethylene, polypropylene or nylon film substrates, once the film is coated with a radiation-cured coating, such that the printed image still flakes and “picks off' the substrate film layer. Moreover, although the Edlein et al. '127 patent lists poly(vinyl butyral) among the typical carrier resins used in standard inks, poly(vinyl butyral) is disfavored due to its poor dot fidelity in the flexographic printing technique preferred by Edlein et al.

Although the use of radiation-cured or electron beam coatings on thermoplastic packaging films has become increasingly more common, such coatings have met with limited success when used over a printed film layer. Such electron beam coated films are more complex than originally thought. One has to identify the proper film substrate, the proper coating chemistry/components and the proper ink chemistry. All of these variables must work in concert to have a successful printed packaging film that can withstand the abuses that can occur during manufacturing, as well as shipping and handling. Conventional ink systems, such as nitrocellulose-based and polyamide-based ink systems, are satisfactory for applying printed images to thermoplastic films that are not subsequently coated with an electron beam cured coating. However, when an electron beam cured coating is applied to such printed thermoplastic films, the ability of the ink to adhere to the thermoplastic film tends to fail, resulting in cracking and flaking of the printed image.

There exists a need in the art for an improved printed coated thermoplastic film that has satisfactory adhesion and performance characteristics such that the printed layer can withstand the abuses associated with manufacturing, shipping and handling.

### BRIEF SUMMARY OF THE INVENTION

One aspect of the presently described technology is directed to a coated, printed thermoplastic film material for packaging applications wherein the thermoplastic film material comprises a substrate film formed from at least one thermoplastic material, a printed image formed on the substrate film, the printed image being formed from at least one ink system which comprises a polyvinyl butyral carrier resin, a pigment dispersed in the resin, from about 10% to about 40% by weight of a plasticizer and from about 0.5% to about 5% by weight of a coupling agent, and an energy curable coating formed over the printed image. The use of a polybutyral carrier resin modified with a plasticizer and a coupling agent provides better adhesion of the ink system to the substrate film, compared to conventional nitrocellulose and polyamide ink systems, when an energy curable coating is formed over the printed image.

In a further aspect, the presently described technology is directed to a method of forming a printed, coated thermoplastic packaging material comprising the steps of (a) providing a thermoplastic packaging material; (b) forming a printed image on at least one surface of the thermoplastic packaging material using at least one ink system comprising a polyvinyl butyral carrier resin, a pigment dispersed in the carrier resin, a plasticizer, and a coupling agent; (c) applying an energy curable coating over the printed image; and (d) exposing the energy curable coating to ionizing radiation to form a cured coating on the printed image.

While the presently described technology will be described in connection with one or more preferred embodiments, it will be understood by those skilled in the art that it is not limited to those embodiments. On the contrary, the presently described technology includes all alternatives, modifications, and equivalents as may be included within the spirit and scope of the appended claims.

### DETAILED DESCRIPTION OF THE PREFERRED EMBODIMENTS

Substrate films suitable for use in preparing a printed, coated thermoplastic film packaging material may be monolayer films, however, multilayer films having two or more layers are preferred.

Thermoplastic polymers useful for making the substrate film include, but are not limited to, polyolefins including homopolymers, copolymers, terpolymers and blends thereof. Examples of suitable thermoplastic polyolefins can include polyethylene, such as low density polyethylene (LDPE), linear low density polyethylene (LLDPE), high density polyethylene (HDPE), polypropylenes, ethylene-propylene copolymers, polyamides, such as various nylons, polymers made using a single-site catalyst, ethylene maleic anhydride copolymers, ethylene vinyl acetate copolymers, (EVA's), polymers using Zeigler-Natta catalysts, styrene-containing block copolymers, blends thereof and coextruded structures thereof.

When the substrate film is a multilayer film, the film typically comprises a core layer and one or more outer skin layers adjacent to the core layer. The core layer is typically one or more of the thermoplastic polymers recited above, but can also include other polymers that have a low permeance to oxygen and/or water vapor depending upon the characteristics and/or application of the resultant film desired. Such polymers include, but are not limited to, ethylene vinyl alcohol (EVOH), polyvinyl dichloride (PVDC), and polyalkylene carbonate. The skin layer or layers may have the same or different composition than that of the core. Typically, the skin layers are comprised of polypropylene, polyethylene, or polyamide polymers. One or more tie layers can be included in the multilayer film to provide increased adhesion between the other layers. Useful polymers for the tie layers include, but are not limited to, anhydride-modified polyolefin, ethylene/unsaturated acid copolymer, and mixtures thereof.

The substrate film layer or layers may also include other optional components to improve the film properties or processing of the film, as is known in the art. Such optional components may include, for example, one or more anti-oxidants, one or more processing aids, anti-blocking agents, slip agents, pigments, deodorizers and antimicrobial agents.

The substrate film may be made using a variety of film-forming processes known in the art. For example, the film may be manufactured by casting, or extrusion using blown film, coextrusion or free-film extrusion techniques.

The substrate films used herein can have any total thickness desired as long as the films provide suitable performance characteristics for the desired packaging application. Thus, the total thickness of the films, as well as the thickness of the individual layers of a multilayer film, will depend at least in part on the construction of the package and its end use. In general, however, the substrate films of the present technology will have a total thickness in the range of about 0.01 to about 0.5 mm, more preferably in the range of about 0.02 to about 0.25 mm.

Regardless of the structure and end use of the substrate films, the substrate films are printed with an image utilizing an ink system that has been found to have improved adhesion to the substrate film compared to conventional nitrocellulose-based ink systems. The ink system of the present technology comprises at least one pigment dispersed in a polyvinyl butyral carrier resin, a solvent, and further comprises from about 10% to about 40% by weight of the total ink system of a plasticizer, and from about 0.5% to about 5% by weight of the total ink system of a coupling agent, such as an acrylated polysiloxane.

The pigment or pigments used in the ink system are commercially available pigments known in the art. Such pigments and combinations thereof can be used to make various colors, including white, black, blue, yellow, red, green, orange, purple, violet, cyan and magenta. Typically, the pigment or pigments are present in the ink system in an amount of about 10% to about 30% by weight of the total ink system, more preferably about 15% to about 25% by weight. The particular pigments selected and the amounts used will depend upon the design and nature of the image to be printed on the film substrate.

The pigment or pigments are dispersed in a polyvinyl butyral carrier resin. Polyvinyl butyral carrier resins are known in the art. Such a carrier resin, when modified by the addition of a plasticizer and a coupling agent, as described in more detail below, surprisingly has been found to have better adhesion to the film substrate than nitrocellulose and polyamide carrier resins after an electron beam cured coating has been applied over the printed image. While not wishing to be bound by a particular theory, it is believed that the polyvinyl butyral carrier resin has better flexibility than either of the nitrocellulose or polyamide carrier resins, and that this flexibility leads to improved adhesion of the printed image to the substrate following the application of an electron beam cured coating. The polyvinyl butyral carrier resin may be present in the ink system in an amount of about 5% to about 25% by weight of the total ink system, preferably about 10% to about 20% by weight.

The ink system also includes one or more solvents which can be water, a hydrocarbon solvent or solvents, or a mixture thereof. Suitable hydrocarbon solvents include short chain alcohols, such as ethanol, propanol or isopropanol, aliphatic hydrocarbons, aromatic hydrocarbons, such as toluene, acetates, ketones, and mixtures thereof. A suitable amount of solvent for the ink system is about 25% to about 55% by weight of the total ink system, more suitably about 30% to about 50% by weight.

A plasticizer is added to the ink system in an amount of about 10% to about 40% by weight of the ink system, alternatively in an amount of about 20% to about 30% by weight. Amounts of plasticizer lower than about 10% may not be sufficient to achieve adequate adhesion of the printed image to the substrate film, while amounts greater than 40% can result in diminished color intensity of the ink. Suitable plasticizers are those which introduce an amorphous phase into the solid resin matrix and provide further softening of the ink film. One example of a suitable plasticizer is a polyurethane.

Although the addition of the plasticizer to the ink system results in improved adhesion of the printed image to the substrate film, even better adhesion is achieved if a coupling agent is added to the ink system along with the plasticizer. A preferred coupling agent is a silane, such as an acrylated polysiloxane. Examples of suitable silanes include, but are not limited to, vinyltrimethoxysilane, vinyltriethoxysilane, gamma aminopropyltriethoxysilane, and N-hexyltrimethoxysilane, which are available from Advanced Polymer, Inc., Degussa AG, Crompton Corporation (formerly CK Witco), Power Chemical Corporation, Shin-Etsu Chemical Co., Ltd., and many other suppliers. While not wishing to be bound by a particular theory, it is believed that the silane coupling agent functions as a grafting agent to graft the ink used to form the printed image to the thermoplastic film substrate when the printed substrate is exposed to electron beam radiation during the subsequent coating step. It is also believed that the silane coupling agent similarly grafts the electron beam coating to the printed image resulting in improved adhesion of the electron beam coating, as well as the printed image, to the thermoplastic film substrate.

To form the printed image, one or more layers of ink are printed on the thermoplastic film substrate. There are a variety of suitable printing techniques known in the art that may be used to form the printed image. For example, gravure, rotary screen and flexographic techniques are suitable methods for forming the printed image. The printed image may be, for example, printed words, printed graphics or designs, a solid color (including white) ink layer, or combinations thereof. Accordingly, as used herein the term “printed image” is intended to encompass any application of the ink system to the thermoplastic film.

Once the printed image has been formed on the thermoplastic film substrate, a radiation-curable coating is applied over the printed image and the coating is cured by application of radiation. The coating is formed from one or more radiation-curable components which, when exposed to a radiant energy source, form a highly cross-linked or polymerized coating over the printed image.

The radiation curable components include one or more polymers or oligomers and may, optionally, be mixed with one or more copolymerizable monomers. Suitable examples of the radiation-curable components include, but are not limited to, reactive vinyl monomers, such as (meth)acrylic acid-based derivatives, vinyl acetate, polyesters, and polyurethanes.

Useful radiation-curable coating materials are also commercially available. Particularly useful radiation-curable coating materials are acrylic-based coatings available from Sun Chemicals, Coating Concept, Inc., and Northwest Coatings.

The radiation-curable coating materials can have a viscosity ranging from about 1 cps to about 1000 cps or more (measured at 25° C.) depending upon the method to be used for applying the coating material. Viscosities of greater than about 450 cps typically require slower application speeds, and viscosities lower than about 20 cps may result in a coating that is too thin or unevenly applied. Viscosities ranging from about 20 to about 350 cps (measured at 25° C.) are preferred.

The radiation-curable coating materials may be applied to the printed image by any suitable method, such as gravure, flexographic, rotary screen, roll, or metering rod coating techniques. Such methods are well known in the art.

After the radiation-curable coating material is applied over the printed image, the printed thermoplastic film is introduced into an electron beam radiation chamber where it is exposed to electron beam radiation to crosslink or polymerize the radiation-curable components into a hardened flexible coating. Electron beam radiation chambers that are suitable for use in forming the cured coating are commercially available from Energy Sciences, Inc. and American International Technologies. The electron beam chamber can be operated in a low oxygen or inert environment by introducing a nitrogen blanket into the chamber.

The amount or dosage of radiation delivered to the radiation-curable coating material is selected such that at least about 80%, more preferably at least about 90%, still more preferably at least about 95%, and most preferably about 100% of the reactive sites on the radiation-curable components polymerize and/or cross-link to form the coating. Suitable radiation dosages are in the range of from about 1.0 to about 10 megarads (Mrad), more preferably in the range of from about 2 to about 5 Mrad. Useful radiation energies for generating the radiation dosages are in the range of from about 50 to about 250 kiloelectron volts (keV), more preferably from about 80 to about 120 keV.

The coated, printed thermoplastic film can be formed into packages suitable for enclosing products, such as food products. Such packages may be in the form of pouches, bags, or other like packages that are formed by heat sealing the coated, printed film to itself or another film layer to form the package. Suitable packages may also include vertical form, fill and seal (VFFS) packages or horizontal form, fill and seal (HFFS) packages.

Regardless of the particular shape of the package and its method of manufacture, by utilizing the ink system of the present technology to form the printed image on the coated, printed thermoplastic film, the printed packaging material is able to withstand the rigors of shipping and handling with minimal cracking and flaking of the printed image.

The ability of a printed thermoplastic packaging material to withstand the abuses that the packaging material may undergo during shipping and handling may be measured by the “crinkle resistance test.” The crinkle resistance test is conducted by grasping the packaging material between one's thumbs and forefingers and rubbing the packaging material against itself, ink side to ink side, in a circular motion in increments of 10 rubs or cycles. The test is conducted to the point of perceived failure and the number of cycles at the point of failure is noted. Although it is somewhat subjective, failure is defined as the point at which the ink used to form the printed image flakes and cracks, and the package appearance is rendered unacceptable. The more cycles a printed image can withstand before flaking and cracking, the better its crinkle resistance. The better the crinkle resistance of a printed packaging material, the more likely it will have the ability to stand up to the abuses of shipping and handling.

The polyvinyl butyral ink system of the present technology performs about two to three times better than conventional nitrocellulose-based ink systems with respect to crinkle resistance. Preferably, the polyvinyl butyral ink system achieves a crinkle resistance test rating of at least 60 cycles, more preferably at least 80 cycles, and most preferably at least 100 cycles. In addition, the polyvinyl butyral ink system of the present technology can be used in combination with nitrocellulose-based ink systems to improve the adhesion of the nitrocellullose-based ink to the substrate thermoplastic film. Such improved adhesion can be achieved by applying the polyvinyl butyral-based ink of the present technology as a first or base coat ink layer on the thermoplastic film substrate, and thereafter applying the nitrocellulose-based ink in subsequent ink layers to form the printed image. Without wishing to be bound by a particular theory, it is believed that the polyvinyl butyral-based ink system of the present technology provides a foundation or base coat that assists in promoting the adhesion of conventional nitrocellulose-based inks to the thermoplastic film substrate, resulting in improved crinkle resistance of conventional nitrocellulose-based ink systems.

In order to better understand the preferred embodiments and the advantages of the present technology, reference may be had to the following examples. However, the examples should not be construed to limit the scope of the invention.

### Example 1

Two different film substrates, one having a polypropylene outer skin layer, and the other having a low density/linear low density polyethylene outer skin layer were printed with the polyvinyl butyral-based ink system of the present technology and/or a conventional nitrocellulose-based ink system available from Sun Chemicals under the name Flexomax. The film formulations are set forth below in Table 1.

TABLE 1

| | | | | % By Wt | Melt | |
|---|---|---|---|---|---|---|
| Film | Layer | % of Film | Composition | of Layer | Index | Density |
| 1304.4 | A | 18% | hPP | 100% | 2 | 0.9 |
| 2.25 mils | (outer | | | | | |
| | skin) | | | | | |
| | B | 47% | hPP | 80% | 2 | 0.9 |
| | | | LLDPE | 20% | — | 0.919 |
| | C | 35% | EVA | 48% | 2 | 0.926 |
| | | | Anti-block- | 2% | 6.5 | 1.047 |
| | | | agent | | | |
| | | | mPE | 50% | 1.6 | 0.895 |
| K108 | A | 20% | LDPE | 35% | 2 | 0.926 |
| 2.25 mils | (outer | | LLDPE | 65% | 2 | 0.919 |
| | skin) | | | | | |
| | B | 60% | hPP | 80% | 1 | 0.9 |
| | | | LLDPE | 20% | — | 0.919 |
| | C | 20% | EVA | 48% | 2 | 0.926 |
| | | | Anti-block- | 2% | 6.5 | 1.047 |
| | | | agent | | | |
| | | | mPE | 50% | 1.6 | 0.895 |

Each film sample is printed on a Kopac 400 printing press with either blue and dark blue polyvinyl butyral-based inks, or blue and dark blue conventional nitrocellulose-based inks (available from Sun Chemicals, Inc. under the trade name of Flexomax). Some of the film samples are also printed with a white polyvinyl butyral-based ink comprising 2% by weight of a silane coupling agent in accordance with the present technology as a first or base ink layer. The ink systems used are set forth in Table 2.

TABLE 2
INK SYSTEMS

| | | | | Flexomax Dark |
|---|---|---|---|---|
| PVB White | PVB Blue | PVB Dark Blue | Flexomax Blue | Blue |
| PVB carrier | PVB carrier | PVB carrier | Nitrocellulose | Nitrocellulose |
| 20% Polyurethane | 20% Polyurethane | 20% Polyurethane | 20% Polyurethane | 20% Polyurethane |
| 2% silane | 0% silane | 0% silane | 2% silane | 2% silane |
| coupling agent | coupling agent | coupling agent | coupling agent | coupling agent |

The film samples are coated with Sun Beam R3319-1032B, which is a radiation-curable coating available from Sun Chemicals, Inc. comprising a mixture of acrylate oligomers and alkyl acrylate esters. The coated films are then loaded into an electron beam radiation unit and exposed to 3 Mrad of radiation at a radiation energy of 90 keV to cure the coatings. The radiation unit is operated at a pressure of 1.2×10⁻⁶ torr with an oxygen concentration of 35 ppm 0₂.

Each of the coated, printed film samples are subjected to the crinkle resistance test to evaluate adhesion of the printed image to the substrate film. Details and results are shown in Table 3 below.

TABLE 3

| | Sample | | | | | | |
|---|---|---|---|---|---|---|---|
| | 1 | 2 | 3 | 4 | 5 | 6 | 7 |
| Film | 1304.4 | K108 | 1304.4 | K108 | 1304.4 | 1304.4 | K108 |
| Outer film | hPP | LD/LLD | hPP | LD/LLD | hPP | hPP | LD/LLD |
| layer | | | | | | | |
| White | PVB | | PVB | | | | PVB |
| Blue Color | PVB | PVB | Flexomax | Flexomax | PVB | Flexomax | PVB |
| Dark Blue | PVB | PVB | Flexomax | Flexomax | PVB | Flexomax | PVB |
| Coating | 1032B | 1032B | 1032B | 1032B | 1032B | 1032B | 1032B |
| Crinkle | 100 | 100 | 60 | 40 | 60 | 20 | 150 |

From the results shown in Table 3, it may be seen that films printed with the polyvinyl butyral-based ink system of the present technology had 2-3 times better crinkle resistance than the films printed with only conventional nitrocellulose-based inks. Compare Sample 5, which achieved 60 cycles in the crinkle resistance test using PVB ink to Sample 6, which achieved only 20 cycles in the crinkle resistance test, and Sample 2, which achieved 100 cycles in the crinkle resistance test using PVB ink on a different substrate to Sample 4, which achieved only 40 cycles in the crinkle resistance test using nitrocellulose ink on the same substrate as Sample 2. Even better crinkle resistance is obtained when the silane coupling agent is added to the PVB ink, and the modified PVB ink is used as a base coat. Compare Sample 1, which achieved 100 cycles in the crinkle resistance test using the modified PVB ink, to Samples 5 and 6, and compare Sample 7, which achieves 150 cycles in the crinkle resistance test to Samples 2 and 4, which did not use the modified PVB ink as a base coat. Further, it can be seen from a comparison of the crinkle resistance results from Samples 3 and 6, that use of the polyvinyl butyral-based ink of the present technology as a base coat can improve the adhesion of conventional nitrocellulose-based inks to the film substrate.

### Example 2

Various thermoplastic film substrates were prepared and printed with a base layer of polyvinyl butyral-based white ink containing polyurethane as a plasticizer and a silane coupling agent. Colored ink systems comprising either polyvinyl butyral-based ink or nitrocellulose-based ink (Flexomax) were printed over the white ink layer. Each of the printed films were coated with Sun Beam 7622 electron beam coating available from Sun Chemical. The electron beam unit conditions were 90 keV and 3 Mrads. Adhesion of the printed image on each of the film samples was evaluated by the crinkle resistance test. Details and results are set forth in Table 4.

TABLE 4

| | Sample | | | | | | | | | |
|---|---|---|---|---|---|---|---|---|---|---|
| | 1 | 2 | 3 | 4 | 5 | 6 | 7 | 8 | 9 | 10 |
| Substrate | hPP | hPP | hPP | 30% EMA | 30% EMA | hPP | hPP | m-LLD | 30% EMA | 30% EMA |
| | | | | (20% MA)/ | (24% MA)/ | | | | (20% MA)/ | (24% MA)/ |
| | | | | 70% hPP | 70% hPP | | | | 70% hPP | 70% hPP |
| White | PVB | PVB | PVB | PVB | PVB | PVB | PVB | PVB | PVB | PVB |
| Color | PVB | PVB | PVB | PVB | PVB | Flexomax | Flexomax | Flexomax | Flexomax | Flexomax |
| Coating | 7622 | 7622 | 7622 | 7622 | 7622 | 7622 | 7622 | 7622 | 7622 | 7622 |
| Adhesion by | Pass | Pass | Pass | Pass | Pass | Pass | Pass | Pass | Pass | Pass |
| 3M Tape 600 | | | | | | | | | | |
| Adhesion by | Pass | Pass | Pass | Pass | Pass | Pass | Pass | Pass | Pass | Pass |
| 3M Tape 610 | | | | | | | | | | |
| Crinkle | 100 | 100 | 100 | 100 | 100 | 30 | 60 | 60 | 60 | 60 |
| Gloss 45 | 42-45 | 42-44 | 44-45 | 44-46 | 44-47 | 38-40 | 38-41 | 40-43 | 42-44 | 43-46 |
| Gloss 60 | 60-63 | 60-64 | 58-65 | 64-68 | 66-70 | 54-60 | 56-60 | 50-55 | 57-65 | 63-67 |

From the results in Table 4, it can be seen that better crinkle resistance is achieved with the polyvinyl butyral-based ink system of the present technology as compared to a conventional nitrocellulose-based ink system.

From the foregoing, it will be appreciated that although specific embodiments of the present technology have been described herein for purposes of illustration, various modifications may be made without deviating from the spirit or scope of the technology.

1. A coated, printed thermoplastic film for packaging applications comprising:
a substrate film formed from at least one thermoplastic material;
a printed image formed on the substrate film, the printed image being formed from at least one ink system which comprises a polyvinyl butyral carrier resin, a pigment dispersed in the carrier resin, a plasticizer and a coupling agent; and
an energy curable coating formed over the printed image.

2. The thermoplastic film of claim 1, wherein the substrate film comprises a polypropylene polymer.

3. The thermoplastic film of claim 1, wherein the substrate film comprises a polyethylene polymer.

4. The thermoplastic film of claim 1, wherein the printed image is formed from a first ink system which comprises a polyvinyl butyral carrier resin, a pigment dispersed in the carrier resin, a plasticizer and from about 0.5% to about 5% by weight of the ink system of a coupling agent, and at least a second ink system applied over the first ink system.

5. The thermoplastic film of claim 4, wherein the second ink system comprises a polyvinyl butyral carrier resin.

6. The thermoplastic film of claim 4, wherein the second ink system comprises a nitrocellulose carrier resin.

7. The thermoplastic film of claim 1, wherein the plasticizer is present in an amount of about 10% to about 40% by weight of the ink system.

8-13. (canceled)

14. A method of forming a printed, coated thermoplastic packaging material comprising:
providing a thermoplastic packaging material;
forming a printed image on at least one surface of the thermoplastic packaging material using at least one ink system comprising a polyvinyl butyral carrier resin, a pigment dispersed in the carrier resin, a plasticizer, and a silane coupling agent;
applying an energy curable coating over the printed image; and
exposing the energy curable coating to ionizing radiation to form a cured coating on the printed image.

15. The method of claim 14, wherein the thermoplastic packaging material comprises a polypropylene polymer.

16. The method of claim 14, wherein the thermoplastic packaging material comprises a polyethylene polymer.

17. The method of claim 14, wherein the printed image is formed by applying a first ink system, which comprises a polyvinyl butyral carrier resin, a pigment dispersed in the carrier resin, a plasticizer, and a silane coupling agent, to the surface of the thermoplastic packaging material, and applying at least a second ink system over the first ink system.

18. The method of claim 17, wherein the ink systems are applied using rotary screen, gravure, or flexographic techniques.

19. The method of claim 17, wherein the second ink system comprises a polyvinyl butyral carrier resin.

20. The method of claim 17, wherein the second ink system comprises a nitrocellulose carrier resin.

21. The method of claim 14, wherein the plasticizer is present in an amount of about 10% to about 40% by weight of the ink system.

22. The method of claim 21, wherein the plasticizer is polyurethane.

23. The method of claim 14, wherein the silane coupling agent is present in an amount of about 0.5% to about 5% by weight of the ink system.

24. The method of claim 14, wherein the energy curable coating comprises an acrylate.

25. The method of claim 14, wherein the exposing step comprises exposing the energy curable coating to an electron beam radiation source having an energy in the range of about 50 to about 250 keV.

26. The method of claim 25, wherein the electron beam radiation source has an energy in the range of about 80 to about 120 keV.
